(19) United States
(12) Patent Application Publication
(10) Pub. No.: US 2004/0052986 A1
(43) Pub. Date: Mar. 18, 2004

(54) Reinforced paperboard tube

(76) Inventor: Lawrence C. Bank, Madison, WI (US)

Correspondence Address: Intellectual Property Department, DEWITT ROSS & STEVENS S.C., Suite 401, 8000 Excelsior Drive, Madison, WI, 53717-1914, US

(21) Appl. No.: 10/245,109

(22) Filed: Sep. 17, 2002

(51) Int. Cl. B32B 1/08

(52) U.S. Cl. 428/34.2; 428/36.91; 264/134

(57) ABSTRACT

A reinforced paperboard tube is constructed by depositing a polymeric matrix with embedded fibers on a paperboard tube by use of pultrusion processes, resulting in a composite tube with a paperboard inner surface and a composite polymer/fiber outer surface. The resulting composite tube exhibits desired strength and dynamic properties greater than those provided by either the original paperboard tube or the added polymer/fiber shell taken alone. The composite tube is particularly useful in the manufacture of paper or other sheet or strand materials which are rolled onto tubes during manufacturing, since the composite tube allows a low-diameter tube upon which such materials can be wound at very high speeds without the dynamic instability that would otherwise result if plain paperboard or polymer tubes of the same diameter and length were used.

### STATEMENT REGARDING FEDERALLY SPONSORED RESEARCH

This invention was made with United States government support awarded by the National Science Foundation pursuant to NSF Grant No. 9713566. The United States has certain rights in this invention.

### FIELD OF THE INVENTION

This disclosure concerns an invention relating generally to tubes used in the manufacture and storage of spooled materials, and particularly to tubes upon which paper is wound during paper manufacturing.

### BACKGROUND OF THE INVENTION

Paperboard tubes, sometimes referred to as “cores,” are often used in the manufacture and storage of spooled sheet and strand materials, such as paper and string. As an example, in the paper industry, paperboard tubes having approximately 3 inches inner diameter and a radial thickness of 0.5 inches (i.e., 4.0 inches outer diameter), and being 6-8 feet long, are commonly used to wind newly-manufactured paper at speeds of 2,000 feet per second or more. To gain greater manufacturing efficiencies, there have been efforts to attain winding speeds of 3,000 feet per second or more with tubes having lengths of up to 14 feet. However, longer tubes are dynamically unstable at these speeds owing to flexural vibration, and the instability is not cured unless the diameter of a paperboard tube is increased to around 8-9 inches. This is problematic not only owing to the decreased volume of paper the tube can accommodate, but also because most paper manufacturing equipment is not built to handle tubes of this size, and new or substantially overhauled equipment would be required to accommodate the larger tubes. The problem is not easily remedied by simply adopting tubes made of other materials (such as metals) owing to costs, processing concerns (e.g., the need to have a tube which allows its inner circumference to be readily grasped by a chuck or other equipment), and the benefits of certain properties of paperboard (e.g., the gripping effect generated by the frictional properties of paperboard). As a result, the paper manufacturing industry has reached a substantial obstacle to increasing the efficiency and speed of manufacturing operations. Similar pressures are felt in other industries using paperboard tubes as well, such as in the manufacture of metal foils.

### SUMMARY OF THE INVENTION

The invention involves a reinforced paperboard tube which is intended to at least partially solve the aforementioned problems. To give the reader a basic understanding of some of the advantageous features of the invention, following is a brief summary of preferred versions of the tube, the processes used to manufacture the preferred versions, and the usage of the preferred tubes. As this is merely a summary, it should be understood that more details regarding the preferred versions may be found in the Detailed Description set forth elsewhere in this document. The claims set forth at the end of this document then define the various versions of the invention in which exclusive rights are secured.

A preferred implementation of the invention involves a reinforced paperboard tube wherein a polymeric matrix with embedded fibers is deposited on a paperboard tube by use of pultrusion processes, resulting in a composite tube with a paperboard inner surface and a composite polymer/fiber outer surface. The resulting reinforced tube is preferably a true composite, i.e., the matrix is bonded to and acts synergistically with the paperboard tube so that the performance of the resulting tube is greater than that provided by either the original paperboard tube or the added polymer/fiber shell taken alone. The bonding is promoted by the use of polymers which appropriately adhere to the (preferably) porous paperboard, and by the use of a seamed tube (e.g., a spiral-wound tube), whereby the polymeric matrix may seep into the seams when the composite tube is being formed.

The resulting composite tube has light weight and high stiffness and radial strength, and its range of operating speeds is greatly expanded so that greater processing speeds can be used without the danger of dynamic instability. Since the interior surface of the tube is still formed of paperboard material, it may be internally chucked or otherwise gripped in the same manner as prior paperboard tubes, and it thereby does not require new or specialized equipment to accommodate its usage. The cost of the composite tube is not substantially increased, particularly taking into account the productivity benefits resulting from its usage.

Further advantages, features, and objects of the invention will be apparent from the following detailed description of the invention in conjunction with the associated drawings.

### BRIEF DESCRIPTION OF THE DRAWINGS

FIG. 1 is an exploded diagrammatic view of an exemplary composite tube 100 produced as per the invention, illustrating a paperboard strip 108 being spirally wound about a mandrel 10 to form an interior paperboard tube 102 (this portion of the composite tube 100 being shown in perspective), and an outer polymeric matrix 104 with embedded fibers 106 to be applied to the outer surface of the paperboard tube (the matrix 104 being shown cross-sectionally in exploded form, spaced from the paperboard tube 102).

FIG. 2 is a cross-sectional view of a section of an exemplary completed composite tube 100 as per the invention, illustrating the polymeric matrix 104 (and fibers 106) deposited upon a spiral-wound paperboard tube 102 with the polymeric matrix 104 having seeped into the seams 116 formed by the adjacent edges 110 of the paperboard strip 108 forming the paperboard tube 102. (It should be understood that the size of the seams 116 is exaggerated for purposes of clearer illustration.)

FIG. 3 is a simplified perspective view of an exemplary application of the invention, wherein the composite tube 100 is internally grasped by a chuck of a paper winding apparatus.

### DETAILED DESCRIPTION OF PREFERRED EMBODIMENTS OF THE INVENTION

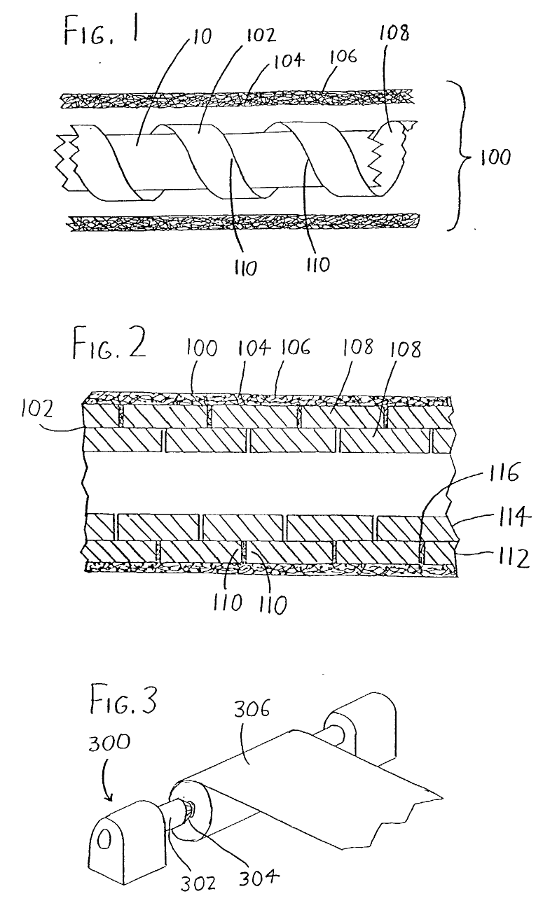

Referring to FIGS. 1 and 2, the structure and composition of a preferred version of the reinforced paperboard tube 100, also referred to as simply the composite tube 100, may be visualized. A helically-wound paperboard tube 102—shown in exploded/expanded form in FIG. 1—is used as a central mandrel in a pultrusion process wherein a polymeric matrix 104 and reinforcing fibers 106 are deposited on the paperboard tube 102 (which is fed through the pultrusion process along with the polymeric matrix 104 and fibers 106). The structure of the composite tube 100 will first be discussed, followed by a discussion of its manufacture and end use.

Regarding the paperboard tube 102, the term “paperboard tube” encompasses tubes which are made of primarily lignocellulosic materials that are commonly referred to as “cardboard” or “fiberboard.” Such tubes 102 may be circular in cross-section or polygonal, e.g., triangular, square/rectangular, and so on. FIG. 1 illustrates the paperboard tube 102 as being formed from a helically wound paperboard strip 108, wherein the strip 108 is wound about a mandrel 10 until its opposing edges 110 are closely spaced, with adhesive generally being applied to the opposing edges 110 to maintain the paperboard tube 102 in a tubular shape. Usually, multiple helically-wound strips 108 are overlaid in multiple adhered layers for greater strength (with only a single strip 108 being illustrated in FIG. 1 for sake of simplicity, and dual layers being illustrated in FIG. 2, with an outer layer 112 being formed from one strip 108 which defines the outer surface of the tube 102 and an inner layer 114 being formed from another strip 108 which defines the inner surface of the tube 102). While paperboard tubes 102 formed from helically wound strips 108 are particularly preferred for use in the invention for reasons to be discussed below, it should be understood that the invention is not limited to the use of paperboard tubes 102 formed from helically-wound strips 108, and it could instead use integrally formed paperboard tubes 102, or paperboard tubes 102 formed of rolled sheets having seams extending parallel to the axis of the tubes (or seams oriented in other directions).

The polymeric matrix 104, with fibers 106 embedded therein, is pultruded onto the outer surface of the paperboard tube 102 (i.e., atop any outer layer 112) so that it firmly and integrally adheres to the paperboard tube 102. While FIG. 1 depicts the polymeric matrix 104 adjacent a yet-to-be-formed paperboard tube 102, which is itself situated on a mandrel 10, the polymeric matrix 104 will generally simply be deposited on acompletely formed/wound paperboard tube 102, and no internal mandrel 10 is necessary during deposition of the polymeric matrix 104 because the paperboard tube 102 itself serves as the pultrusion mandrel. (In other words, in FIG. 1, the unwound state of the paperboard tube 102, and the presence of the mandrel 10, are merely shown for illustrative purposes.) While a paperboard tube 102 might be wound and then continuously fed to a pultruder immediately after winding, such a continuous forming process leads to greater expense and difficulty because most tube-winding apparata require use of a rotating central mandrel 10, which is not as easily accommodated in a continuous-feed pultrusion process. Additionally, the rate of tube production in most spiral-winding tube manufacturing apparata is much faster than the throughput speed in most pultrusion apparata, so much of the capacity of a conventional tube manufacturing apparatus may be wasted if placed directly inline with a conventional pultruder (since the pultruder will form a “bottleneck” in the output of the tube manufacturing apparatus). Thus, if the invention is to be implemented using preexisting and readily available machinery, it is contemplated that a paperboard tube 102 would be formed in a first production line/stage, and then the completed paperboard tube 102 would be supplied to a pultruder in a second production line/stage. Otherwise, a continuous-feed production process wherein pultrusion occurs immediately after tube production is best implemented by specially-constructed apparata to avoid wasting capacity.

The polymeric matrix 104 is most preferably formed of thermosetting materials such as thermosetting resins of the polyester, vinyl ester, epoxy, phenolic, aminoplast, or polyurethane types, and derivatives and mixtures thereof. However, other or additional thermosetting materials now known and yet to be developed may be used as well, with the foregoing list merely providing exemplary materials. The matrix 104 can additionally include additives such as (for example) colorants or pigments, lubricants or process aids, ultraviolet light (UV) stabilizers, antioxidants, other fillers, and extenders. The material chosen for use in the polymeric matrix 104 is preferably at least partially absorbable into the outer surface of the paperboard tube 102 (which is generally to some degree porous) to assist in adhesion of the polymeric matrix 104 to the paperboard tube 102. Without such adhesion, the performance of the resulting composite tube 100 is degraded because the inner paperboard tube 102 and the outer tube formed of the polymeric matrix 104 will act separately, rather than synergistically as in a true composite. Thus, process parameters should be chosen such that when the polymeric matrix 104 cures, it does not define an outer polymeric tube 104 which can readily separate from the inner paperboard tube 102.

Regarding avoidance of separation between the paperboard tube 102 and the polymeric matrix 104, the degree of adhesion between the tube 102 and matrix 104 can also be enhanced if the outer surface of the paperboard tube 102 bears discontinuities into or around which the polymeric matrix 104 can flow and solidify. While adhesion could be enhanced by taking steps such as increasing the porosity of the paperboard tube 102, roughening its outer surface, or similar measures, it has been found that adhesion is greatly enhanced when at least any outer layer 112 of the paperboard tube 102 is formed of a helically wound paperboard strip 108. As depicted in FIG. 2, the polymeric matrix 104 flows into the seams 116 between the adjacent edges 110 of the paperboard strip 108 of the outer layer 112 so that the strip 108 is effectively embedded in the polymeric matrix 104 (with the seams 116 being illustrated with exaggerated size in FIG. 2 for sake of clearer illustration). This has been found to occur even where the seams 116 of a spirally-wound paperboard tube 102 are extremely tight and are filled with adhesive, since the pressure of the pultrusion process (and heat, if any heating is used) are generally sufficient to nonetheless inject the polymer within the seams 116. As a result, it is sometimes found that if the paperboard tube 102 is peeled from the interior of the composite tube 100 to leave the outer tube formed of the polymeric matrix 104, this outer tube bears an internal spiral rib running along its length, with this rib corresponding to the location of the seam 116 on the outer layer 112 of the inner paperboard tube 102.

The fibers 106 used to produce the reinforced paperboard tube 102 can be of any type or form suitable for use in pultrusion processes, including individual fibers or rovings (grouped fibers) made of glass, carbon, synthetics (including thermosetting and thermoplastic types), ceramics, or metals, or combinations thereof. Fibers 106 of high stiffness, such as carbon, glass, or aramid (KEVLAR) are particularly preferred. The fibers 106 may be provided in continuous strand, chopped, woven or mat form (or in combinations thereof). Forms of fibers 106 preferred for ease of manufacture are continuous-strand unidirectional fibers, and/or mats of discontinuous-strand nondirectional fibers, since continuous strands and formed mats are easily situated about the entire circumference of the paperboard tube 102 while feeding it through the pultrusion guides/dies.

The relative proportions of the polymeric matrix 104 and fibers 106 may vary according to the strength/stiffness desired for the final reinforced tube, but a fiber-to-matrix volume ratio of at least 30% is preferred when the invention is implemented for paper manufacturing purposes, with a range of 50-60% being most preferred. The proportions of the polymeric matrix 104 and its embedded fibers 106 with respect to the paperboard tube 102 may also vary depending on the properties desired, but when the invention is implemented for paper manufacturing purposes, the polymeric matrix 104 and fibers 106 are preferably applied at a radial thickness of 5%-15% the radial thickness of the paperboard tube 102.

Any standard pultrusion processes can be used to form the composite tube 100. A standard preexisting process for pultruding polymer/fiber tubes (with no paperboard interior) involves unspooling fibers 106 (in individual fiber, roving, or mat/fabric form), impregnating them with thermosetting resin (as by passing them through a bath), and then drawing the impregnated fibers 106 through one or more preform plates into one or more dies having a central mandrel. The thermosetting material then solidifies, usually owing to heat applied in the pultruder die (either via external heating and/or from die pressure) and/or from the presence of crosslinking agents in the matrix 104, though other curing processes might be used to achieve solidification. The emerging length of pultruded tube, which assumes a constant cross-sectional area defined by the shape of the die cavity, is then cut into desired lengths by a cutoff saw. Such a tube pultrusion system can be modified to produce the composite tube 100 by removing its central mandrel 10, and instead providing an additional infeed system which supplies a continuous paperboard tube 102 (or discrete lengths of tubes 102) in the prior location of the central mandrel 10. Thus, the prior tube manufacturing process is modified to replace its stationary central mandrel 10 (which is generally formed of metal) with a central mandrel made of paperboard tube 102 which is fed into the pultruder for application of the polymeric matrix 104, and which emerges from the pultruder as the composite tube 100. The composite tubes 100 produced in accordance with the invention may have any desired dimensions which can be achieved by use of pultrusion processes, with outer diameters of 0.5-12 inches being readily achievable by use of common pultruders. The polymeric matrix 104 can have any desired thickness which is achievable by use of standard pultruders, with thicknesses of 0.05-1.5 inches being easily achievable (keeping in mind that curing times may increase as the thickness of the matrix 104 increases).

The resulting composite tubes 100 are beneficially used in the field of paper manufacturing. An exemplary paper winding apparatus is illustrated in FIG. 3 at the reference numeral 300, wherein the composite tube 100 is internally grasped by a winding spindle 302 having a chuck 304 at its end, and with the composite tube 100 being driven to wind a paper roll 306 onto the composite tube 100. Since the high modulus polymeric matrix 104 is situated on the exterior of the paperboard tube 102, it provides a significant contribution to the overall moment of inertia of the composite tube 100 (and thus to its natural frequency). Tubes 100 having diameters of 3-8 inches, and lengths of 6-14 feet, can be run at speeds of 3,000 feet/second without instability, allowing installation of the composite tubes 100 in preexisting paper manufacturing equipment with a significant increase in processing speed. The composite tubes 100 do not cost substantially more than conventional paperboard tubes, particularly taking into account the productivity benefits they provide. Since the interior of the composite tube 100 is bounded by the inner paperboard tube 102, it may be internally chucked in the same manner as conventional paperboard tubes and no equipment modifications are required to accommodate the composite tube 100. Chucking advantages are also obtained because greater (radially outwardly directed) chucking forces may be used without deformation of the composite tube 100 or penetration of its surface, thereby avoiding the problem of conventional paperboard tubes of waste of the innermost paper layers wound onto the tubes owing to their piercing by the chuck or their deformation from deformity of the paperboard tube. Additionally, with appropriate choice of the polymeric matrix 104 and embedded fibers 106 (and their relative content), the frictional properties of the composite tube 100 may be modified as desired, and the composite tube 100 may even be tailored to have frictional characteristics that are more desirable than those provided by conventional paperboard tubes 102. If desired, only the outer surface of the composite tube 100 may have its frictional properties modified, as by feeding a surface veil or desired surface fibers into the pultruder so that the surface veil and/or fibers rest only at the surface of the pultruded composite tube 100 (with any accompanying interior reinforcing fibers 106 perhaps being chosen more for modification of the overall strength/stiffness characteristics of the composite tube 100, rather than for modification of surface frictional properties).

It is understood that the various preferred versions of the invention are shown and described above to illustrate different possible features of the invention and the varying ways in which these features may be combined. Apart from combining the different features of the foregoing versions in varying ways, other modifications are also considered to be within the scope of the invention. Following is an exemplary list of such modifications.

First, rather than using thermosetting materials for the matrix 104, thermoplastics may be used instead, particularly when pultrusion methodologies using thermoplastics come into more widespread use. Suitable thermoplastics that have thus far been used in pultrusion methods include polyolefins (e.g., polyethylene, polypropylene, polybutene, polyisoprene, neoprene), polyamides, thermoplastic polyurethanes, thermoplastic polyesters, vinyl polymers (e.g., polyvinyl chloride, polyvinylidene chloride), polystyrenes, and derivatives and mixtures thereof. Other or additional materials may be used as well, with the foregoing list simply giving examples.

Second, while the invention was primarily developed for use in the paper manufacturing industry, it is useful in the manufacture of other spooled materials as well. As an example, the manufacture of metal sheets/foils is subject to different considerations than paper manufacturing; in particular, high radial strength is needed for the tubes upon which sheet metals are wound, in order to avoid buckling. The composite tubes 100 produced by the invention have exceptionally high radial strength, higher even than some grades of steel, and thus are useful in sheet metal manufacture as well. Additionally, the composite tubes 100 of the invention may be useful in non-manufacturing fields. As an example, they might be used as poles, rails, beams, or other structural members.

The invention is not intended to be limited to the preferred versions of the invention described above, but rather is intended to be limited only by the claims set out below. Thus, the invention encompasses all different versions that fall literally or equivalently within the scope of these claims.

What is claimed is:

1. A reinforced paperboard tube comprising:
a. an inner paperboard tube having an inner surface and an outer surface;
b. an outer polymeric matrix pultruded atop the inner paperboard tube, the outer polymeric matrix having an inner surface integrally formed on the outer surface of the inner paperboard tube and having fibers embedded therein.

2. The reinforced paperboard tube of claim 1 wherein the paperboard tube includes at least one helically wound elongated paperboard strip.

3. The reinforced paperboard tube of claim 2 wherein the paperboard strip is maintained in a helically wound configuration solely by the polymeric matrix.

4. The reinforced paperboard tube of claim 1 wherein the paperboard tube includes an elongated paperboard strip having opposing edges extending along its length, and wherein the strip is wound with adjacently situated opposing edges.

5. The reinforced paperboard tube of claim 4 wherein the outer polymeric matrix extends between the opposing edges of the strip.

6. The reinforced paperboard tube of claim 4 wherein the outer polymeric matrix extends between the opposing edges of the strip from the outer surface of the paperboard tube to its inner surface.

7. The reinforced paperboard tube of claim 1 wherein the fibers consist of one or more of glass fibers, carbon fibers, and polymeric fibers.

8. The reinforced paperboard tube of claim 1 wherein the paperboard tube is radially thicker than the polymeric matrix.

9. A process for forming a reinforced paperboard tube comprising the steps of:
a. providing an inner paperboard tube having an inner surface and an outer surface;
b. pultruding an outer polymeric matrix atop the inner paperboard tube, the outer polymeric matrix having an inner surface integrally formed on the outer surface of the inner paperboard tube and having fibers embedded therein.

10. The process of claim 9 wherein:
a. the step of providing an inner paperboard tube includes the step of feeding the inner paperboard tube into a pultruder, and
b. the step of pultruding an outer polymeric matrix atop the inner paperboard tube includes applying the outer polymeric matrix to the outer surface of the inner paperboard tube without the presence of a mandrel inside the inner paperboard tube.

11. The process of claim 9 wherein the step of providing an inner paperboard tube includes the step of helically winding at least one elongated paperboard strip.

12. The process of claim 11 wherein each strip is helically wound about a mandrel, thereby forming the inner paperboard tube on the mandrel.

13. The process of claim 12 wherein the outer polymeric matrix is pultruded atop the inner paperboard tube while it is on the mandrel.

14. The process of claim 9 wherein the step of pultruding an outer polymeric matrix atop the inner paperboard tube includes the steps of:
a. providing the tube on a mandrel;
b. applying the fibers to the outer surface of the tube; and
c. applying polymer to the tube and fibers.

15. The process of claim 14 further comprising the step of applying heat to the tube and fibers after the polymer is applied.

16. A process for using a reinforced paperboard tube, the reinforced paperboard tube including an inner paperboard tube having an outer surface with a polymeric matrix pultruded thereon with fibers embedded within the polymeric matrix, the process comprising winding spoolable material onto the polymeric matrix of the reinforced paperboard tube.

17. The process of claim 16 wherein the spoolable material is paper.

18. The process of claim 17 wherein the paper is wound onto the polymeric matrix of the reinforced paperboard tube at a speed of greater than 2,500 feet/second.

19. The process of claim 18 wherein the reinforced paperboard tube has an outer diameter less than or equal to 8 inches.

20. The process of claim 18 wherein the reinforced paperboard tube has a length greater than 8 feet.
